(19) United States
(12) Patent Application Publication
(10) Pub. No.: US 2016/0127685 A1
(43) Pub. Date: May 5, 2016

(54) VIDEO CONFERENCE MANAGEMENT DEVICE AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 14/792,005

(22) Filed: Jul. 6, 2015

(30) Foreign Application Priority Data
Oct. 31, 2014 (TW) 103137813

(51) Int. Cl. H04N 7/15

(52) U.S. Cl. CPC H04N 7/15

(57) ABSTRACT

A video conference management method includes determining a current video conference mode in response to a mode selection from one or at least one first electronic device, sharing contents displayed on a first display area to each of a number of second electronic devices when the current video conference mode is a broadcast mode, creating a number of groups when the current video conference mode is a group mode, dividing a second display area into a number of second sub-display areas, establishing a video conference connection between the second electronic devices in each group, sharing the contents displayed on each second sub-display area to the second electronic devices in the corresponding group, and sharing the contents displayed on the first display area to the second electronic devices which are excluded from any group.

### CROSS-REFERENCE TO RELATED APPLICATIONS

This application claims priority to Taiwanese Patent Application No. 103137813 filed on Oct. 31, 2014, the contents of which are incorporated by reference herein.

### FIELD

The subject matter herein generally relates to video conference technology, and particularly to a video conference management device and a method thereof.

### BACKGROUND

Transmitting images, voices or other application data in real time between two parties or multi parties are realized by web-based video conference software, and remote conferences, remote teachings, or remote discussions are developed based on the web-based video conference software.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a video conference management device connected to a number of first electronic devices and second electronic devices of one embodiment.

FIG. 2 is a block diagram of a video conference interface of the video conference management device.

FIG. 3 illustrates a flowchart of a video conference management method of one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “comprising” means “including, but not necessarily limited to”, it specifically indicates open-ended inclusion or membership in a so-described combination, group, series and the like.

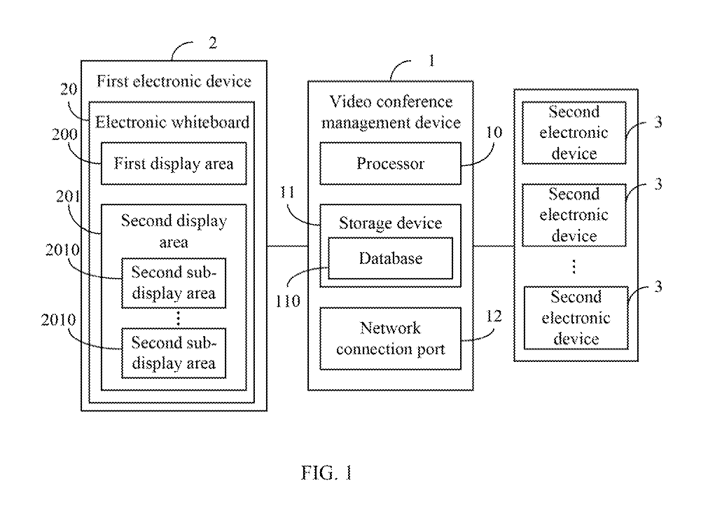

FIG. 1 illustrates a block diagram of a video conference management device 1. The video conference management device 1 includes, but is not limited to, a processor 10, a storage device 11, and a network connection port 12. In one embodiment, the video conference management device 1 can be a server, a workstation, or other suitable electronic devices. FIG. 1 illustrates only one example of the video conference management device 1 that can include more or fewer components than illustrated, or have a different configuration of the various components in other embodiments.

The video conference management device 1 is connected to at least one first electronic device 2 and a number of second electronic devices 3 joined in a video conference, via the network connection port 12. In at least one example, the at least one first electronic device 2 is the electronic device used by people playing roles of chairmen in the video conference, and the number of second electronic devices 3 are the electronic devices used by people playing roles of attendees in the video conference. In at least one example, the network connection port 12 is used for connecting the video conference management device 1 to the at least one first electronic device 2 and the second electronic devices 3 via internet or Local Area Network (LAN).

The at least one first electronic device 2 includes, but is not limited to, an electronic whiteboard 20, and the electronic whiteboard 20 includes a first display area 200 and a second display area 201. The at least one first electronic device 2 and the number of second electronic devices 3 can be personal computers, smart phones, or other suitable electronic devices.

The storage device 11 stores a database 110, which includes information associated with the at least one first electronic device 2 and the number of second electronic devices 3. In at least one example, the information can include, but is not limited to, Internet Protocol (IP) address or Identification (ID) code of the at least one first electronic device 2 and each second electronic device 3.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 10 can be a central processing unit (CPU), a microprocessor, or other data processor chip that performs functions of the video conference management device 1.

In at least one example, the storage device 11 stores one or more programs, when the one or more programs are executed by the at least one processor 10, the one or more programs cause the at least one processor 10 to implement corresponding functions as follows.

The processor 10 determines a current video conference mode in response to a mode selection from one or at least one first electronic device 2. In at least one example, the mode selection from the at least one first electronic device 2 is a selecting instruction for selecting the mode of the video conference, input by one chairman via the corresponding first electronic device 2.

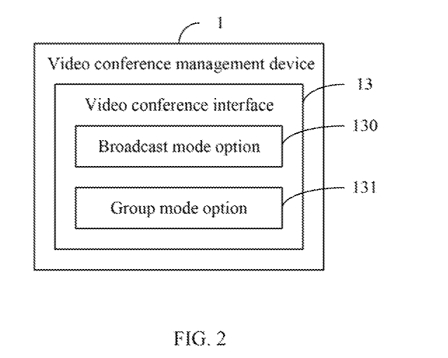

FIG. 2 illustrates a block diagram of a video conference interface 13 of the video conference management device 1, the processor 10 provides the video conference interface 13 in response to a starting instruction received on the first at least one electronic device 2, the video conference interface 13 includes, but is not limited to, a broadcast mode option 130 and a group mode option 131, the chairmen inputs the selecting instruction via selecting the broadcast mode option 130 or the group mode option 131. The processor 10 determines the mode of the current video conference is a broadcast mode according to the selection on the broadcast mode option 130 generated by the chairmen, and determines the mode of the current video conference is a group mode according to the selection on the group mode option 131 generated by the chairmen.

In at least one example, the at least one first electronic device 2 and the number of second electronic devices 3 are connected to the video conference management device 1 after the users of the at least one first electronic device 2 and the second electronic devices 3, namely the chairmen and attendees, log in a web portal of video conference. When the chairmen and attendees log in the web portal of video conference respectively via the at least one first electronic device 2 and the second electronic devices 3, the video conference management device 1 connects to the first electronic devices 2 and the second electronic devices 3. The chairmen can start the video conference in the web portal by inputting the starting instruction via the first electronic device 2, and the first electronic device 2 displays the video conference interface 13 after the video conference is started.

The processor 10 further acquires the information associated with the number of second electronic devices 3 from the database 110 when the current video conference mode is the broadcast mode, and shares contents displayed on the first display area 200 to each second electronic device 3 according to the acquired information. In at least one example, the current video conference is a teaching conference, the chairmen are teachers, and the attendees are students, the second electronic devices 3 of all of the attendees can receive teaching contents shared on the first display area 200.

The processor 10 further receives a group creation instruction input by the attendees when the current video conference mode is the group mode, and acquires the information associated with the corresponding second electronic devices 3 when receiving the group creation instruction input by the attendees, and creates a number of groups according to the group creation instruction and the acquired information. In at least one example, the attendees are students, and the processor 10 divides the attendees who join in the teaching video conference at the group mode into the number of groups according to the group creation instruction of the attendees.

The processor 10 further divides the second display area 201 into a number of second sub-display areas 2010 according to the number of groups, with each second sub-display area 2010 corresponding to one of the groups. In at least one example, an area occupied by each second sub-display area 2010 in the second display area 201 can be the same or different.

The processor 10 further establishes a video conference connection between the number of second electronic devices 3 in each group, thus establishing a number of video conference connections corresponding to different groups. In at least one example, establishing the video conference connection independently in each group enables different groups to be excluded from conflict during the video conference. For example, in the teaching video conference, the attendees in each group can receive the teaching contents shared by the teachers respectively according to a one-to-one relation between the groups and second sub-display areas 2010.

The processor 10 further shares the contents displayed on each second sub-display area 2010 to the number of second electronic devices 3 in the corresponding group. In at least one example, in the teaching video conference, the attendees in each group can receive the teaching contents shared on the corresponding second sub-display areas 2010, and make a group discussion.

The processor 10 further acquires the information associated with the number of second electronic devices 3 which are excluded from any group, and shares the contents displayed on the first display area 200 to the number of second electronic devices 3 excluded from any group according to the acquired information. In at least one example, the second electronic devices 3 which are excluded from any group can still receive the contents shared in the broadcast mode when the current mode is the group mode. The second electronic devices 3 which are excluded from any group can still receive the content displayed on the first display area 200 even though the current video conference mode is the group mode.

Furthermore, in the broadcast mode, the processor 10 can switch the video conference mode to the group mode in response to the selection on the group mode option 131 generated by the chairmen. In the group mode, the processor 10 also can switch the video conference mode to the broadcast mode in response to selection on the broadcast mode option 130 generated by the chairmen.

The processor 10 further determines an attendee as a group chairman in each group, shares the contents displayed on each second sub-display area 2010 to the second electronic device 3 of the corresponding group chairman, and shares the contents displayed on each second electronic device 3 of the group chairman to the second electronic devices 3 of the other attendees of the corresponding group. In at least one example, the group chairmen can summarize the result of the corresponding group discussion to the chairmen of the video conference if necessary. In other embodiments, the processor 10 selects an attendee from each group randomly, and determines the selected attendee of each group as the group chairman in each group.

The processor 10 detects whether there are attendees logging out from the group, if one or more attendees log out from the group, the processor 10 cancels the second electronic devices 3 which log out from the group, and still shares the contents displayed on the second sub-display areas 2010 to the second electronic devices 3 of the remaining attendees in the group.

The processor 10 further detects whether there is the group chairman logging out from one group, if one group chairman logs out from the group, the processor 10 cancels the group, and still shares the contents displayed on the first display area 200 to the second electronic devices 3 of the attendees who are excluded from any group.

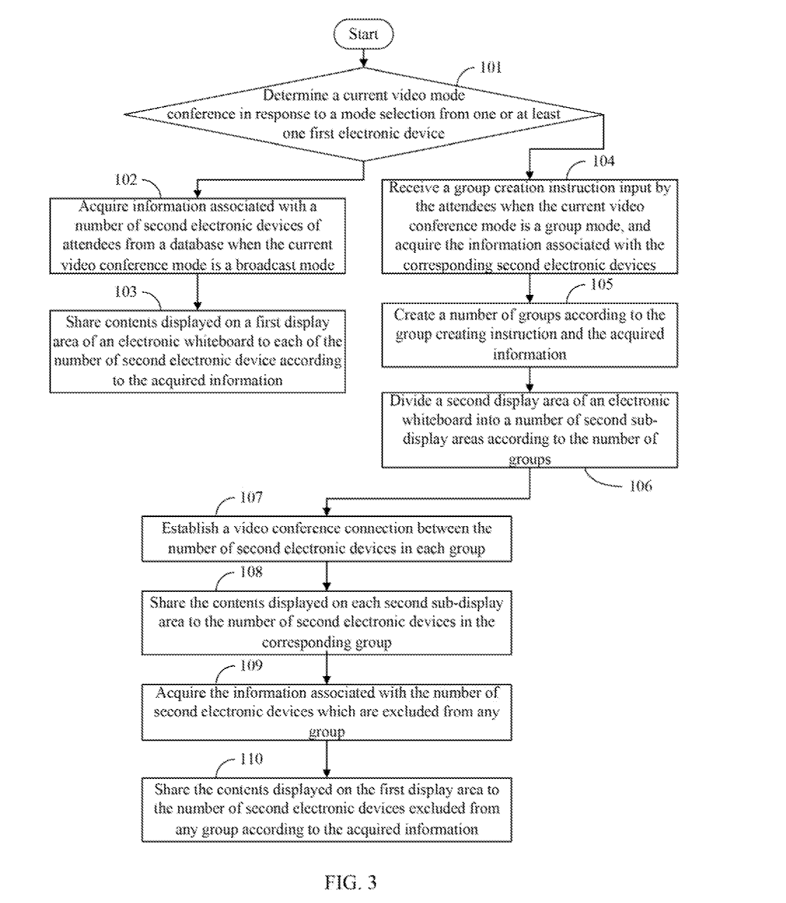

FIG. 3 illustrates a flowchart of a video conference management method. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, a processor determines a current video conference mode in response to a mode selection from one or at least one first electronic device.

At block 102, the processor acquires information associated with a number of second electronic devices of attendees from a database, when the current video conference mode is a broadcast mode.

At block 103, the processor shares contents displayed on a first display area of an electronic whiteboard of the at least one first electronic device to each of the number of second electronic devices according to the acquired information.

At block 104, the processor receives a group creation instruction input by the attendees when the current video conference mode is a group mode, and acquires information associated with the corresponding second electronic devices when receiving the group creation instruction input by the attendees.

At block 105, the processor creates a number of groups according to the group creation instruction and the acquired information.

At block 106, the processor divides a second display area of the electronic whiteboard of the at least one first electronic device into a number of second sub-display areas according to the number of groups, with each second sub-display area corresponding to one of the groups.

At block 107, the processor establishes a video conference connection between the number of second electronic devices in each group.

At block 108, the processor shares the contents displayed on each second sub-display area to the number of second electronic devices in the corresponding group.

At block 109, the processor acquires the information associated with the number of second electronic devices which are excluded from any group.

At block 110, the processor shares the contents displayed on the first display area to the number of second electronic devices excluded from any group according to the acquired information.

Furthermore, the method includes the processor switching the current video conference mode to the group mode in response to the selection generated by the chairmen in the broadcast mode, and switching the current video conference mode to the broadcast mode in response to the selection generated by the chairmen in the group mode.

In one embodiment, the method further includes the processor determining an attendee as a group chairman in each group, sharing the contents displayed on each second sub-display area to the second electronic device of the corresponding group chairman, and sharing the contents displayed on each second electronic device of the group chairman to the second electronic devices of the other attendees of the corresponding group.

In one embodiment, the method further includes the processor detecting whether there are attendees logging out from the group, if one or more attendees log out from the group, canceling the second electronic devices which log out from the group, and sharing the contents displayed on the second sub-display areas to the second electronic devices of the remaining attendees in the group.

In one embodiment, the method further includes the processor detecting whether there is the group chairman logging out from one group, if one group chairman logs out from the group, canceling the group, and sharing the contents displayed on the first display area to the second electronic devices of the attendees who are excluded from any group.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A video conference management device comprising:
a network connection port configured to connect to at least one first electronic device and a plurality of second electronic devices;
a storage device configured to store one or more programs and a database, the database comprising information associated with the at least one first electronic device and the plurality of second electronic devices;
at least one processor configured to execute the one or more programs, wherein when the one or more programs being executed by at least one processor, the one or more programs cause the at least one processor to:
determine a current video conference mode in response to a mode selection from one or the at least one first electronic device;
acquire the information associated with the plurality of second electronic devices from the database when the current video conference mode is a broadcast mode;
share contents which are displayed on a first display area of an electronic whiteboard of the at least one first electronic device to each of the plurality of second electronic devices according to the acquired information;
receive a group creation instruction input by attendees when the current video conference mode is a group mode;
acquire the information associated with the corresponding plurality of second electronic devices when receiving the group creation instruction input by the attendees;
create a plurality of groups according to the group creation instruction and the acquired information;
divide a second display area of the electronic whiteboard of the at least one first electronic device into a plurality of second sub-display areas according to the plurality of groups, wherein each second sub-display area corresponds to one of the groups;
establish a video conference connection between the plurality of second electronic devices in each group;
share the contents displayed on each second sub-display area to the plurality of second electronic devices in the corresponding group;
acquire the information associated with the plurality of second electronic devices which are excluded from any group; and
share the contents displayed on the first display area to the plurality of second electronic devices excluded from any group according to the acquired information.

2. The video conference management device according to claim 1, wherein the at least one processor is further caused to switch the broadcast mode to the group mode or switch the group mode to the broadcast mode in response to the corresponding mode selection.

3. The video conference management device according to claim 1, wherein the at least one processor is further caused to determine an attendee as a group chairman in each group, share the contents displayed on each second sub-display area to the second electronic device of the corresponding group chairman, and share the contents displayed on each second electronic device of the group chairman to the second electronic devices of the other attendees of the corresponding group.

4. The video conference management device according to claim 3, wherein the at least one processor is further caused to detect whether there is one group chairman logging out from the corresponding group, cancel the group if one group chairman logs out from the group, and still share the contents displayed on the first display area to the second electronic devices of the attendees who are excluded from any group.

5. The video conference management device according to claim 1, wherein the at least one processor is further caused to detect whether there are attendees logging out from the group, cancel the second electronic devices which log out the from group, and still share the contents displayed on the second sub-display areas to the second electronic devices of the remaining attendees in the group.

6. A video conference management method being executed by at least one processor of a video conference management device, the method comprising:
determining a current video conference mode in response to a mode selection from one or at least one first electronic device;
acquiring information associated with a plurality of second electronic devices from a database when the current video conference mode is a broadcast mode;
sharing contents which are displayed on a first display area of an electronic whiteboard of the at least one first electronic device to each of the plurality of second electronic devices according to the acquired information;
receiving a group creation instruction input by attendees when the current video conference mode is a group mode;
acquiring the information associated with the corresponding plurality of second electronic devices when receiving the group creation instruction input by the attendees;
creating a plurality of groups according to the group creation instruction and the acquired information;
dividing a second display area of the electronic whiteboard of the at least one first electronic device into a plurality of second sub-display areas according to the plurality of groups, wherein each second sub-display area corresponds to one of the groups;
establishing a video conference connection between the plurality of second electronic devices in each group;
sharing the contents displayed on each second sub-display area to the plurality of second electronic devices in the corresponding group;
acquiring the information associated with the plurality of second electronic devices which are excluded from any group; and
sharing the contents displayed on the first display area to the plurality of second electronic devices excluded from any group according to the acquired information.

7. The video conference management method according to claim 6, further comprising:
switching the broadcast mode to the group mode or switching the group mode to the broadcast mode in response to the corresponding mode selection.

8. The video conference management method according to claim 6, further comprising:
determining an attendee as a group chairman in each group;
sharing the contents displayed on each second sub-display area to the second electronic device of the corresponding group chairman; and
sharing the contents displayed on each second electronic device of the group chairman to the second electronic devices of the other attendees of the corresponding group.

9. The video conference management method according to claim 8, further comprising:
detecting whether there is one group chairman logging out from the corresponding group;
canceling the group if one group chairman logs out from the group; and
sharing the contents displayed on the first display area to the second electronic devices of the attendees who are excluded from any group.

10. The video conference management method according to claim 6, further comprising:
detecting whether there are attendees logging out from the group;
canceling the second electronic devices which log out from the group; and
sharing the contents displayed on the second sub-display areas to the second electronic devices of the remaining attendees in the group.
